(19) United States
(12) Patent Application Publication
(10) Pub. No.: US 2026/0058320 A1
(43) Pub. Date: Feb. 26, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(72) Inventors: Shuya IKEDA, Osaka (JP); Osamu NAKAYAMA, Osaka (JP); Kotaro TAKADA, Osaka (JP); Katsushi MIYAZAKI, Osaka (JP); Takami IZAWA, Kanagawa (JP); Masayuki NAKAI, Kanagawa (JP); Yasuhiro YANAGIHARA, Kanagawa (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(21) Appl. No.: 19/117,724

(22) PCT Filed: Oct. 4, 2023
(86) PCT No.: PCT/JP2023/036204

§ 371 Date: Apr. 2, 2025

(30) Foreign Application Priority Data
Oct. 6, 2022 (JP) 2022-161667

(51) Int. Cl. H01M 50/503; H01M 50/209; H01M 50/298

(52) U.S. Cl. CPC H01M 50/503; H01M 50/209; H01M 50/298

(57) ABSTRACT

A wiring module is to be coupled to a battery stack member that includes laminated type batteries having electrode leads and being stacked and the electrode leads of the laminated type batteries are overlapped and connected and configured as connection portions. The wiring module is to be coupled to the battery stack member that includes the connection portions in a coupling direction that is perpendicular to a plate thickness direction of the connection portions. The wiring module includes terminals, electric wires connected to the terminals, and a protector holding the terminals and the electric wires. The protector includes terminal housing portions in which the terminals are disposed, and protector side fitting portions that hold the terminals so as to be movable in the plate thickness direction with respect to the terminal housing portions between a first position and a second position.

### TECHNICAL FIELD

The present disclosure relates to a wiring module.

### BACKGROUND ART

A high-pressure battery pack that is used in an electric automobile or a hybrid automobile normally includes battery cells that are disposed on top of each other and are electrically connected in series or in parallel to each other with a wiring module. A battery module that is disclosed in Japanese Translation of PCT International Application Publication No. 2020-527848 (Patent Document 1 described below) has been known as an example of such a wiring module. The battery module described in Patent Document 1 includes a cell assembly, a module housing, and end frames. The cell assembly includes battery cells that have electrode leads at front and rear end portions thereof and are stacked in a right-left direction. The module housing has four side walls including upper and lower side walls and right and left side walls. The module housing has an inner space defined by the four side walls and the cell assembly is disposed in the inner space. The end frames are attached to front and rear ends of the cell assembly and the cell assembly and an external device are electrically connected via the end frames.

### PRIOR ART

### Patent Document

Patent Document 1: Japanese Translation of PCT International Application Publication No. 2020-527848

### SUMMARY OF THE INVENTION

### Problem to be Solved by the Invention

In the configuration described above, the electrode leads of the adjacent battery cells are bent to be closer to each other and overlapped so as to be electrically connected. In such a configuration, busbars for connecting the electrode leads are not necessary. The electrode leads are electrically connected to module terminals on the end frames. However, manufacturing tolerances are likely to be caused in the connected portions of the electrode leads particularly in the front-rear direction due to the bending of the electrode leads and welding of the electrode leads.

In attaching the end frames to the cell assembly by moving the end frames from an upper side to a lower side, the module terminal may hit the electrode lead due to the manufacturing tolerances of the electrode lead with respect to the front-rear direction and the module terminal or the electrode lead may be damaged.

### Means for Solving the Problem

A wiring module according to the present disclosure is to be coupled to a battery stack member that includes laminated type batteries having electrode leads being stacked and the electrode leads of the laminated type batteries are overlapped and connected and configured as connection portions. The wiring module is to be coupled to the battery stack member that includes the connection portions in a coupling direction that is perpendicular to a plate thickness direction of the connection portions. The wiring module includes terminals, electric wires connected to the terminals, and a protector holding the terminals and the electric wires. The protector includes terminal housing portions in which the terminals are disposed, and protector side fitting portions that hold the terminals so as to be movable in the plate thickness direction with respect to the terminal housing portions between a first position and a second position. The second position is on one side with respect to the first position in the plate thickness direction. The electrode leads include connection electrode leads that are configured as the connection portions. The terminals include electrode connection portions that are electrically connected to the connection electrode leads. The terminals include electrode connection portions that are electrically connected to the connection electrode leads, slope surfaces that are continuous to the electrode connection portions and are inclined toward the one side with respect to the plate thickness direction as the slope surfaces extend toward a back side in the coupling direction, and terminal side fitting portions that are fitted to the protector side fitting portions. With one of the terminals being disposed in the first position, corresponding one of the slope surfaces is disposed in a range in which corresponding one of the connection electrode leads is to be disposed with respect to the plate thickness direction.

### Effects of the Invention

According to the present disclosure, a wiring module that can be coupled to a battery stack member such that a terminal does not hit an electrode lead can be provided.

### BRIEF DESCRIPTION OF THE DRAWINGS

FIG. 1 is a perspective view of a battery module according to a first embodiment.

FIG. 2 is a front view of the battery module.

FIG. 3 is an enlarged front view of a portion of the battery module including a terminal housing portion.

FIG. 4 is a rear view of the battery module.

FIG. 5 is an enlarged perspective view of a portion of the battery module including the terminal housing portion.

FIG. 6 is an enlarged perspective view of a protector near the terminal housing portion.

FIG. 7 is a perspective view of a terminal.

FIG. 8 is a perspective view of a battery stack member.

FIG. 9 is a view illustrating the wiring module that is being coupled to the battery stack member in a coupling direction.

FIG. 10 is a cross-sectional view along A-A line in FIG. 2.

FIG. 11 is a view illustrating an end portion of a connection electrode lead being disposed on a back side in the coupling direction with respect to a slope surface with a cross section along B-B line in FIG. 3.

FIG. 12 is a view illustrating an end portion of a connection electrode lead being contacted with the slope surface with the cross section along B-B line in FIG. 3.

FIG. 13 is a cross-sectional view along B-B line in FIG. 3.

FIG. 14 is a cross-sectional view along C-C line in FIG. 3.

FIG. 15 is a cross-sectional view along D-D line in FIG. 3.

FIG. 16 is a cross-sectional view along E-E line in FIG. 11.

FIG. 17 is a view illustrating an end portion of the connection electrode lead being disposed on the back side in the coupling direction when the connection electrode lead is disposed outside a range where the connection electrode lead is to be disposed with respect to a plate thickness direction and closer to the terminal protection portion with respect to a terminal protection portion with a cross section along B-B line in FIG. 3.

FIG. 18 is a view illustrating the connection electrode lead and the electrode connection portion being connected when the connection electrode lead is disposed outside the range where the connection electrode lead is to be disposed with respect to the plate thickness direction and closer to the terminal protection portion with a cross section along B-B line in FIG. 3.

FIG. 19 is a view illustrating an end portion of the connection electrode lead being disposed on the back side in the coupling direction with respect to the slope surface when the connection electrode lead is disposed outside the range where the connection electrode lead is to be disposed with respect to the plate thickness direction and closer to the slope surface with a cross section along B-B line in FIG. 3.

FIG. 20 is a view illustrating the connection electrode lead and the electrode connection portion being connected when the connection electrode lead is disposed outside the range where the connection electrode lead is to be disposed with respect to the plate thickness direction and closer to the slope surface with a cross section along B-B line in FIG. 3.

FIG. 21 is an enlarged front view of a portion of a battery module including a terminal housing portion according to a second embodiment.

FIG. 22 is a view illustrating a connection electrode lead having a bent outer portion being coupled to the wiring module with a cross section along F-F line in FIG. 21.

### MODES FOR CARRYING OUT THE INVENTION

### Description of Embodiments According to the Present Disclosure

First, embodiments according to the present disclosure will be listed and described.

(1) A wiring module according to the present disclosure is to be coupled to a battery stack member that includes laminated type batteries having electrode leads being stacked and the electrode leads of the laminated type batteries are overlapped and connected and configured as connection portions. The wiring module is to be coupled to the battery stack member that includes the connection portions in a coupling direction that is perpendicular to a plate thickness direction of the connection portions. The wiring module includes terminals, electric wires connected to the terminals, and a protector holding the terminals and the electric wires. The protector includes terminal housing portions in which the terminals are disposed, and protector side fitting portions that hold the terminals so as to be movable in the plate thickness direction with respect to the terminal housing portions between a first position and a second position. The second position is on one side with respect to the first position in the plate thickness direction. The electrode leads include connection electrode leads that are configured as the connection portions. The terminals include electrode connection portions that are electrically connected to the connection electrode leads, slope surfaces that are continuous to the electrode connection portions and are inclined toward the one side with respect to the plate thickness direction as the slope surfaces extend toward a back side in the coupling direction, and terminal side fitting portions that are fitted to the protector side fitting portions. With one of the terminals being disposed in the first position, corresponding one of the slope surfaces is disposed in a range in which corresponding one of the connection electrode leads is to be disposed with respect to the plate thickness direction.

According to such a configuration, when the wiring module is coupled to the battery stack member, with the slope surface being fitted to the end portion of the connection electrode lead on the front side with respect to the coupling direction, the terminal moves in the plate thickness direction with respect to the connection electrode lead. Therefore, the terminal is less likely to hit the connection electrode lead.

(2) The terminal housing portions preferably include terminal protection portions that are disposed opposite the electrode connection portions with respect to the plate thickness direction. The slope surfaces are preferably inclined so as to be away from the terminal protection portions as the slope surfaces extend toward the back side with respect to the coupling direction. The connection electrode leads are preferably disposed between the electrode connection portions and the terminal protection portions, respectively, with respect to the plate thickness direction.

According to such a configuration, the terminal can be protected by the terminal protection portion. Furthermore, the connection electrode lead that is disposed between the electrode connection portion and the terminal protection portion can be protected.

(3) The terminal protection portions preferably include protector side slope surfaces at end portions on the back side with respect to the coupling direction and the protector side slope surfaces are preferably inclined toward another side with respect to the plate thickness direction as the protector side slope surfaces extend toward the back side with respect to the coupling direction.

According to such a configuration, even if the connection electrode lead is disposed outside the range where the connection electrode lead is to be disposed with respect to the plate thickness direction and closer to the terminal protection portion, the connection electrode lead is likely to be arranged between the electrode connection portion and the terminal protection portion.

(4) A direction perpendicular to the plate thickness direction and the coupling direction is preferably defined as a terminal width direction, and a dimension of the slope surfaces extending in the terminal width direction is preferably smaller than a dimension of the electrode connection portions extending in the terminal width direction.

According to such a configuration, the electrode connection portion and the connection electrode lead are electrically connected easily.

(5) The slope surfaces are preferably in middle sections of the electrode connection portions with respect to the terminal width direction. The electrode connection portions are preferably continuous to the slope surfaces via trapezoid portions whose dimension extending in the terminal width direction decreases as the trapezoid portions extend toward the back side in the coupling direction. The trapezoid portions preferably have a symmetrical shape with respect to the terminal width direction. End portions of the trapezoid portions on the back side with respect to the coupling direction preferably have a dimension extending in the terminal width direction and the dimension of the end portions of the trapezoid portions is preferably same as a dimension of the slope surfaces extending in the terminal width direction.

According to such a configuration, the electrode connection portion is less likely to hit a portion of the connection electrode lead that is disposed outside the slope surface in the terminal width direction.

(6) The terminal housing portions preferably include stoppers that keep the terminals in the terminal housing portions with respect to the plate thickness direction.

According to such a configuration, the terminal is less likely to be away from the terminal housing portion.

(7) The terminal housing portions preferably include first movement suppress portions that suppress movement of the terminals in the coupling direction and second movement suppress portions that suppress movement of the terminals in the terminal width direction that is perpendicular to the plate thickness direction and the coupling direction.

According to such a configuration, the terminal can be positioned with respect to the terminal housing portion in the coupling direction and the terminal width direction.

(8) The terminal side fitting portions preferably have a plate shape and are preferably disposed vertically with respect to the connection portions. The protector side fitting portions are preferably contacted with the terminal side fitting portions on the back side and a front side with respect to the coupling direction and are preferably configured as the first movement suppress portions.

According to such a configuration, since the terminal side fitting portion has a plate shape that is vertical to the connection portion, when the wiring module is coupled to the battery stack member, the force that is applied to the terminal in the coupling direction is likely to be spread. With the protector side fitting portion being configured as the first movement suppress portion, the configuration of the terminal housing portion can be simplified.

(9) The protector preferably includes a protector body and the terminal housing portions are preferably connected movably to the protector body via a hinge portion.

According to such a configuration, even if the connection electrode lead is disposed outside the range where the connection electrode lead is to be disposed with respect to the plate thickness direction, the connection electrode lead is likely to be arranged between the electrode connection portion and the terminal protection portion.

### Details of Embodiments According to the Present Disclosure

Embodiments according to the present disclosure will be described. The present disclosure is not limited to the embodiments. All modifications within and equivalent to the technical scope of the claimed invention may be included in the technical scope of the present invention.

### First Embodiment

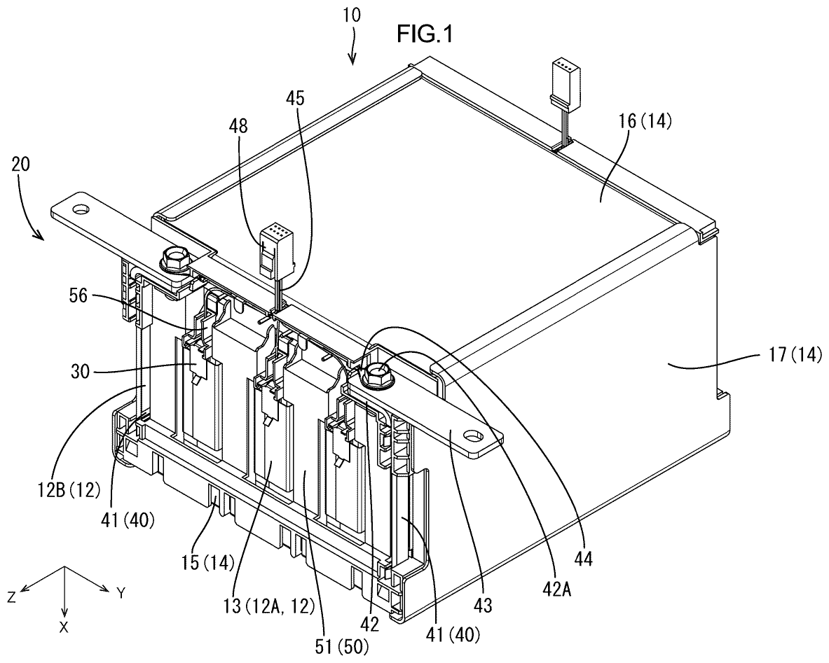

A first embodiment of the present disclosure will be described with reference to FIGS. 1 to 20. A battery module 10 including a wiring module 20 according to this embodiment is installed in a vehicle as a power source for driving a vehicle such as an electric automobile or a hybrid automobile. In the following description, regarding components having the same configuration, some of the components may be indicated by reference signs and others may not be indicated by the reference signs. In the following description, it is considered that an X arrow, a Y arrow, and an Z arrow point the lower side, the left side, and the front side, respectively.

### Battery Stack Member

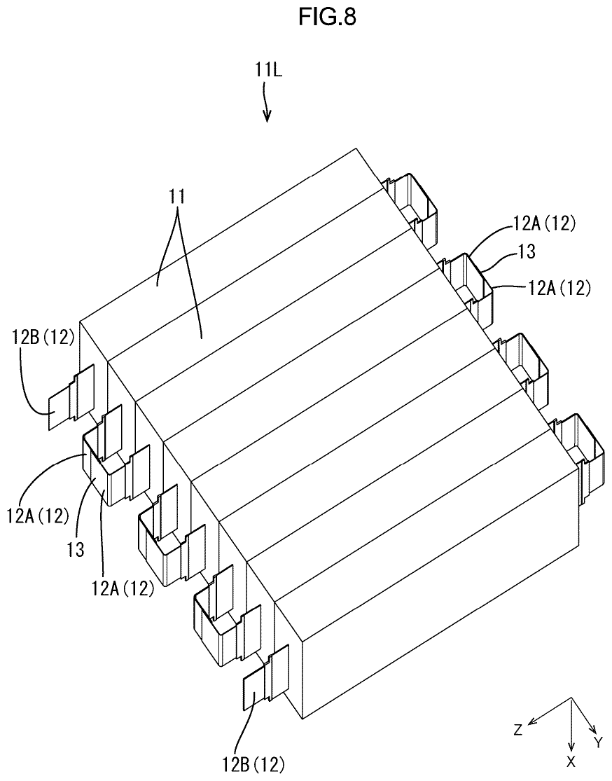

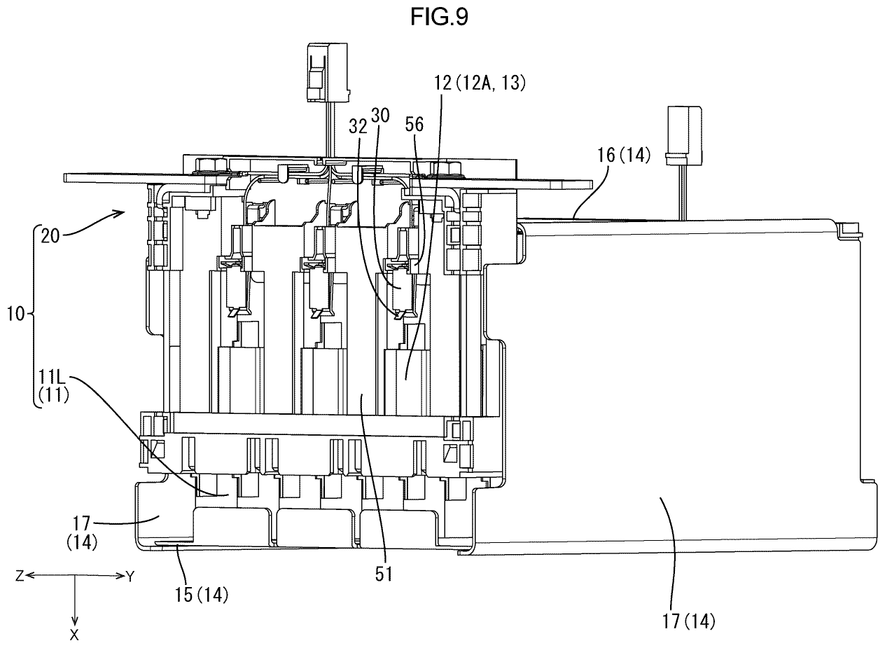

The battery module 10 includes a battery stack member 11L illustrated in FIG. 8 and the wiring modules 20 that are attached to a front side and a rear side of the battery stack member 11L as illustrated in FIG. 9. As illustrated in FIGS. 1 and 9, the battery module 10 of this embodiment further includes a casing 14 that covers the battery stack member 11L from four sides, that are from upper, lower, right, and left sides. The casing 14 includes a bottom portion 15 that is placed on a lower surface side of the battery stack member 11L, a ceiling portion 16 that is placed on an upper surface side of the battery stack member 11L, and a pair of side portions 17 that connect the bottom portion 15 and the ceiling portion 16 on the right and left sides.

### Coupling Direction

As illustrated in FIG. 9, the wiring module 20 of this embodiment is coupled to the battery stack member 11L, which is arranged in the casing 14, in a coupling direction (the direction designated by an arrow X) (details will be described later). In this description, the direction designated by the arrow X is specified as the lower direction and the coupling direction corresponds to the lower direction. However, for example, the battery stack member 11L and the wiring module 20 may be arranged such that the coupling direction corresponds to the front direction or the left direction. The direction corresponding to the direction designated by the arrow X in this description (the width direction of the electrode lead 12) at the time of coupling of the wiring module 20 and the battery stack member 11L may not match the direction corresponding to the direction designated by the arrow X when the battery module 10 is used.

### Laminated Type Battery, Electrode Lead

As illustrated in FIG. 8, the battery stack member 11L includes laminated type batteries 11 (eight laminated type batteries in this embodiment) that are stacked in a right-left direction. The laminated type batteries 11 have a flat shape that is elongated in a front-rear direction and has a small thickness in the right-left direction. The laminated type batteries 11 include power storage elements (not illustrated) therein. The laminated type battery 11 includes a pair of electrode leads 12. The pair of electrode leads 12 are on front and rear sides of the laminated type battery 11, respectively, and protrude from the laminated type battery 11 in opposite directions. The pair of electrode leads 12 have a plate shape and have opposite polarities.

### Connection Portion, Connection Electrode Lead, Plate Thickness Direction, Terminal Width Direction

As illustrated in FIG. 8, the battery stack member 11L includes connection portions 13 where the electrode leads 12 of the adjacent laminated type batteries 11 are electrically connected. The electrode leads 12 are bent leftward or rightward at a right angle and overlapped and connected with welding and thus, the connection portions 13 are formed. A plate thickness direction (the direction of an arrow Z) of the connection portions 13 is defined as the front-rear direction. A direction perpendicular to the plate thickness direction and the coupling direction is defined as a terminal width direction (the direction of an arrow Y, the right-left direction in this embodiment). Some of the electrode leads 12 are configured as the connection portions 13 and are defined as connection electrode leads 12A.

Since a process of forming the connection portions 13 includes a process of bending the electrode leads 12 and a process of laser welding, tolerances of the connection portions 13 (and the connection electrode leads 12A) with respect to the plate thickness direction are particularly likely to become large. For example, in this embodiment, the tolerance of the connection portion 13 (and the connection electrode lead 12A) with respect to the plate thickness direction is a large value compared to a thickness of the electrode lead 12.

As illustrated in FIG. 8, some of the electrode leads 12 other than the connection electrode leads 12A, that are not configured as the connection portions 13, are defined as the end portion electrode leads 12B. The end portion electrode leads 12B are on two end portions of the battery stack member 11L and protrude frontward. The end portion electrode lead 12B is configured as a positive polarity or a negative polarity of the whole battery stack member 11L.

### Wiring Module

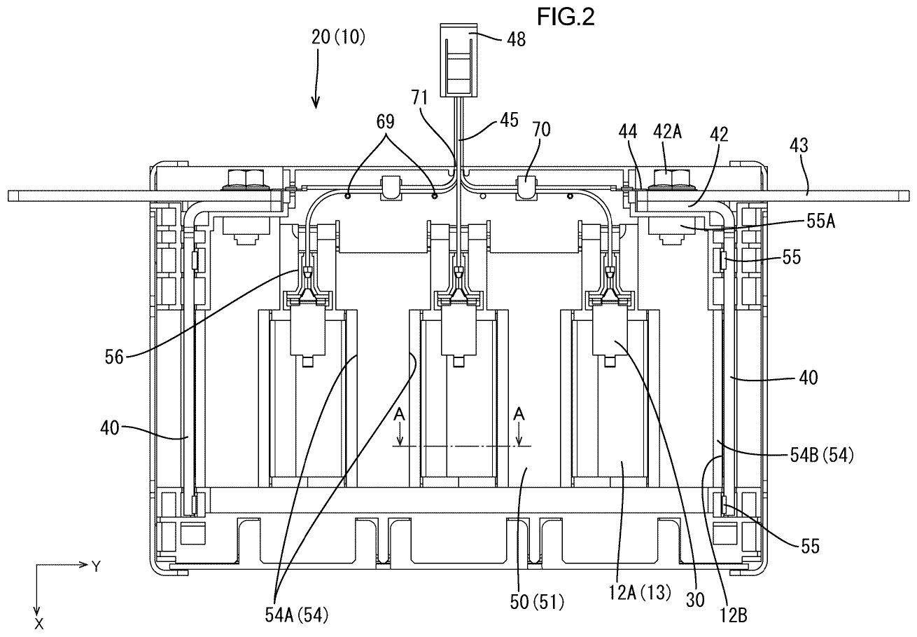

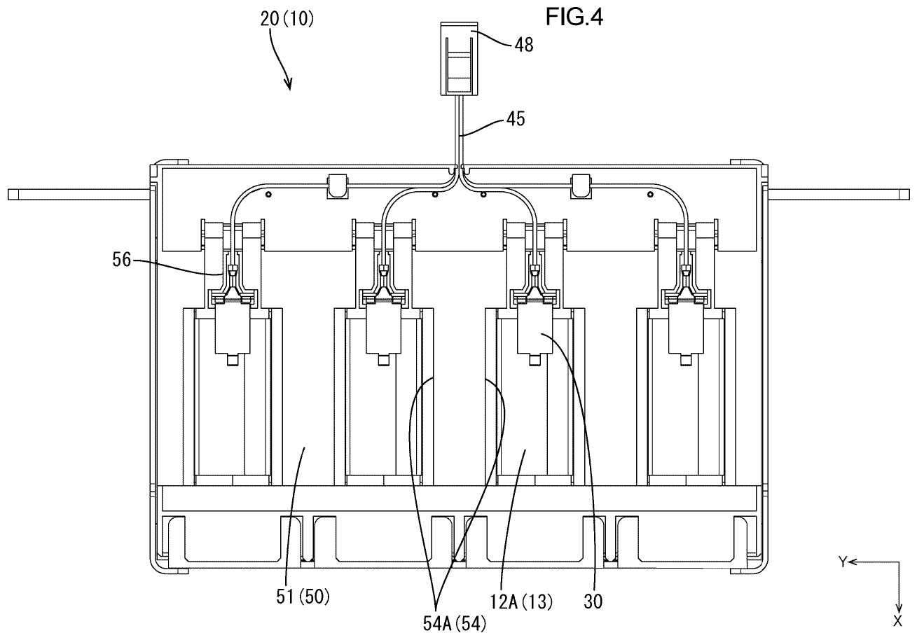

As illustrated in FIG. 2, the wiring module 20 includes terminals 30 that are connected to the connection electrode leads 12A, the busbars 40 that are connected to the end portion electrode leads 12B, electric wires 45 that are connected to the terminals 30 or the busbars 40, and a protector 50 that holds the terminals 30, the busbars 40, and the electric wires 45. In the following, a configuration of the wiring module 20 that is arranged on a front side of the battery stack member 11L will be described in detail. As illustrated in FIG. 4, the wiring module 20 arranged on a rear side of the battery stack member 11L does not include the busbars 40. Besides that, the wiring module 20 on the rear side has a configuration similar to that of the wiring module 20 arranged on the front side of the battery stack member 11L.

### Protector

As illustrated in FIG. 1, the protector 50 is made of synthetic resin having insulating properties and has a plate shape. The protector 50 includes a protector body 51 that is positioned with respect to the casing 14 (and the battery stack member 11L). The detailed configuration of the protector 50 will not be described. The protector body 51 and the casing 14 have protrusions and recessed portions that extend in the coupling direction and are fitted together. According to such a configuration, the wiring module 20 is guided and coupled to the battery stack member 11L.

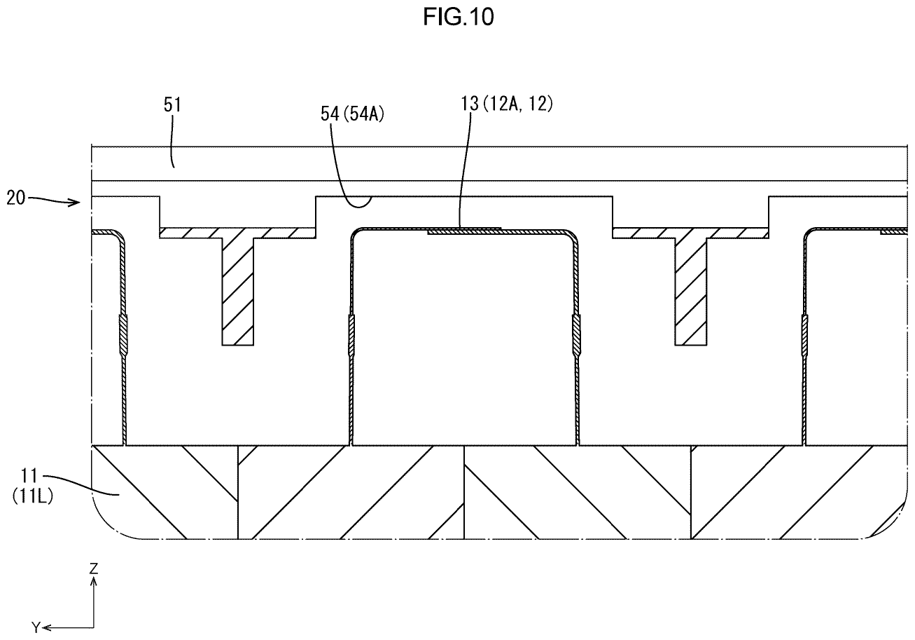

As illustrated in FIG. 2, the protector body 51 includes electrode receiving portions 54 in a middle with respect to the upper-bottom direction. The electrode receiving portions 54 are arranged in the right-left direction and are through in the front-rear direction and have a rectangular shape that is elongated in the upper-bottom direction. The electrode receiving portions 54 include connection electrode receiving portions 54A that receive the connection portions 13 and the connection electrode leads 12A and end portion electrode receiving portions 54B that receive the end portion electrode leads 12B. As illustrated in FIG. 10, the electrode receiving portions 54 also open downward such that the electrode leads 12 do not contact the electrode receiving portions 54 at the time of mounting of the wiring module 20.

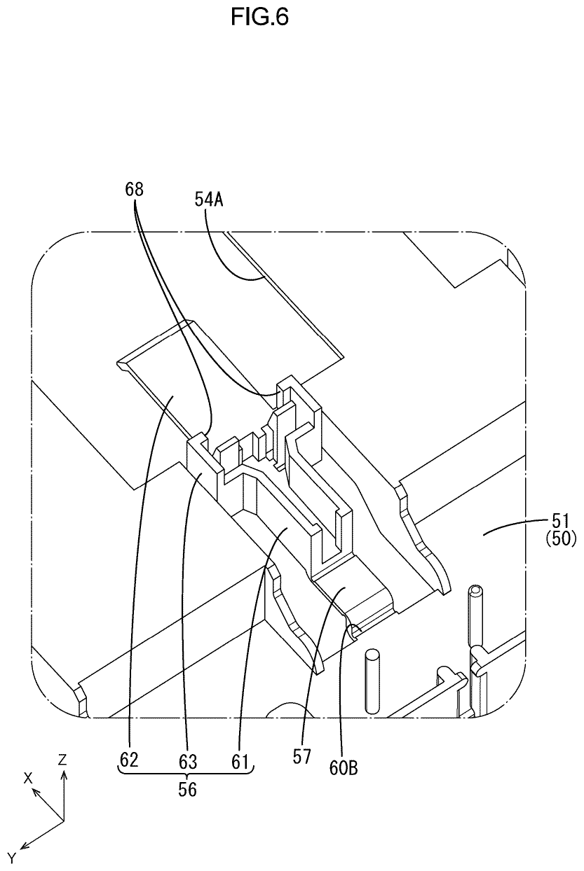

As illustrated in FIG. 2, the end portion electrode receiving portion 54B includes busbar holding portions 55, which hold the busbar 40, on upper and lower portions thereof. A bolt fixing portion 55A for fixing the busbar 40 with a screw is near the upper busbar holding portion 55. As illustrated in FIG. 6, a terminal housing portion 56 is on an upper side section of the connection electrode receiving portion 54A. The terminal 30 is arranged in the terminal housing portion 56. The terminal housing portion 56 is connected to the protector body 51 via a hinge portion 57.

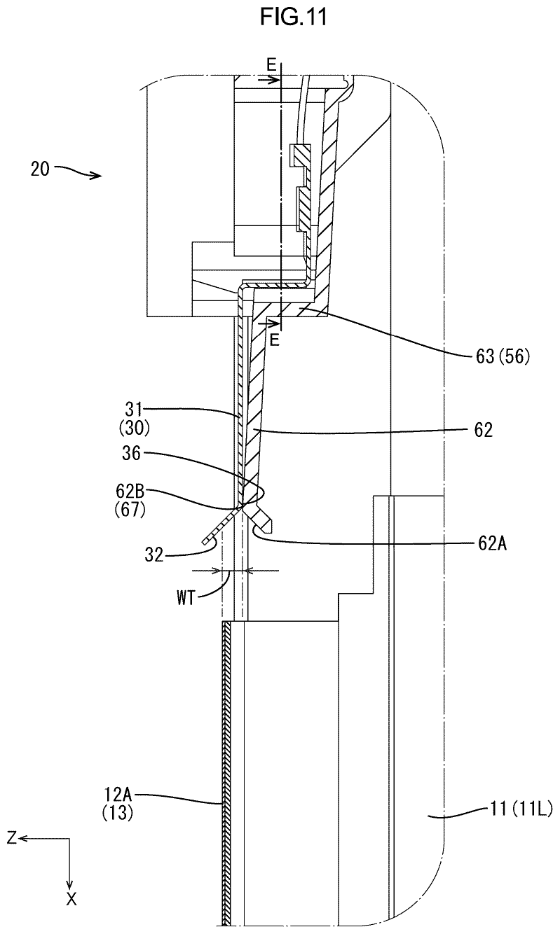

In FIGS. 11 to 14 and FIGS. 17 to 20 that are referred to in the following description, the connection portion 13 (the connection electrode lead 12A), the terminal 30, the terminal housing portion 56, a hinge portion 57, and other components some of which are illustrated with cross sections, are illustrated and some components in the background such as an end portion electrode lead 12B and a busbar 40 are not illustrated for easy understanding.

### Hinge Portion

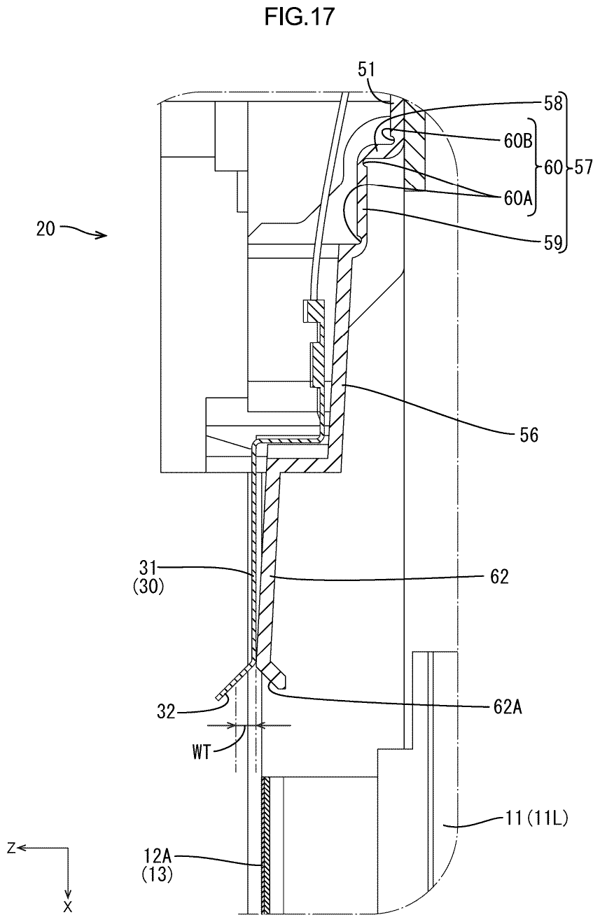

As illustrated in FIG. 17, the hinge portion 57 includes a protrusion section 58 that protrudes frontward from the protector body 51 and an extending section 59 that extends from the protrusion section 58 toward the back side with respect to the coupling direction (downward). The hinge portion 57 includes reduced thickness portions 60 that are reduced in thickness in the plate thickness direction compared to surrounding portions. The reduced thickness portions 60 are included in a joint portion of the terminal housing portion 56 and the extending section 59, a joint portion of the extending section 59 and the protrusion section 58, and a joint portion of the protrusion section 58 and the protector body 51. The reduced thickness portions 60 are formed in a groove having a U-shape with a side view and extend in the right-left direction. The reduced thickness portions 60 at the joint portion of the terminal housing portion 56 and the extending section 59 and the joint portion of the extending section 59 and the protrusion section 58 are defined as first reduced thickness portions 60A. The reduced thickness portion 60 at the joint portion of the protrusion section 58 and the protector body 51 is defined as a second reduced thickness portion 60B. The first reduced thickness portions 60A are thinner than the second reduced thickness portions 60B.

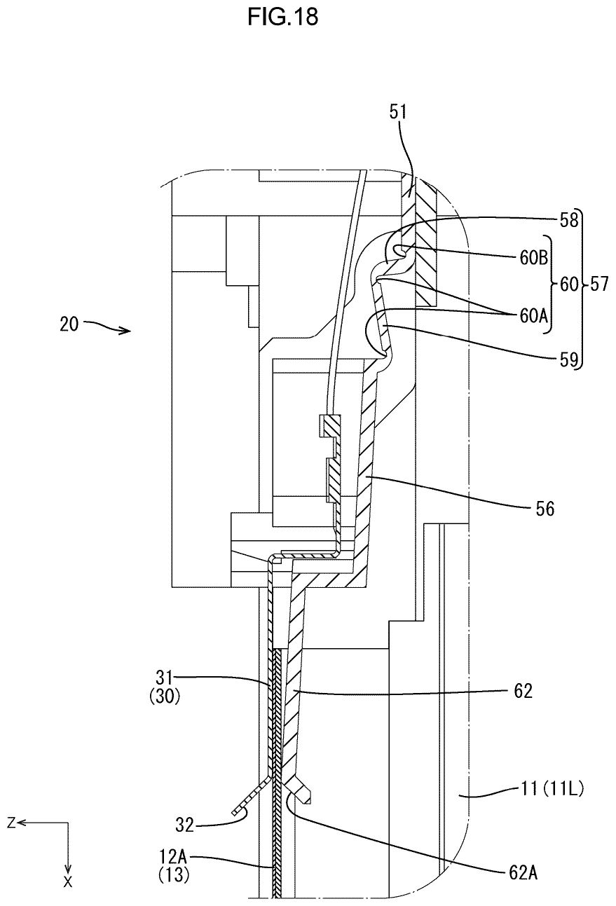

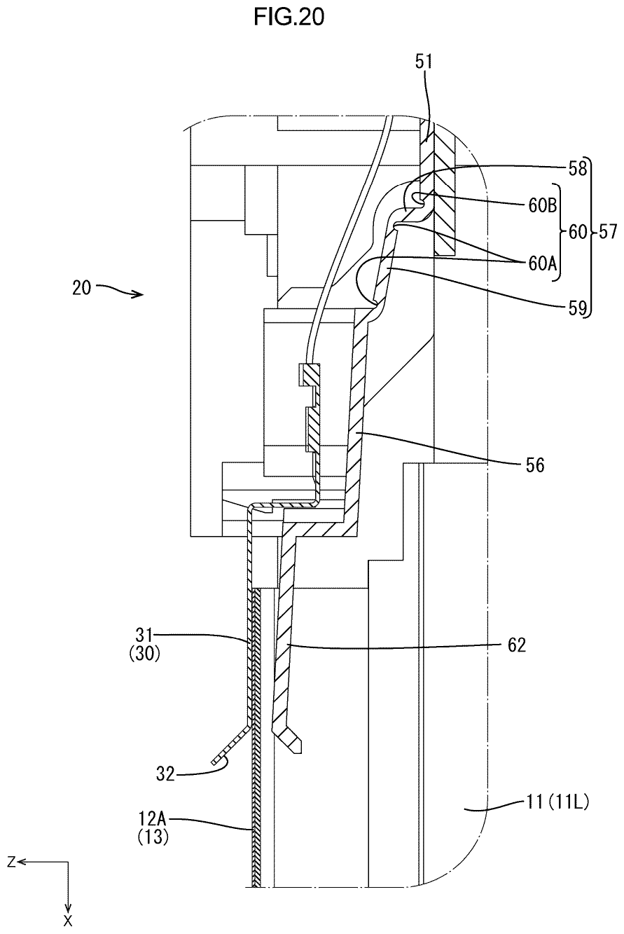

As illustrated in FIGS. 18 and 20, with a force being applied to the terminal housing portion 56, the hinge portion 57 is bent along the reduced thickness portions 60 that function as folding portions and deformed. Namely, with the hinge portion 57 being deformable, the terminal housing portion 56 is movable with respect to the protector body 51. As will be described later, the hinge portion 57 is bent along the first reduced thickness portions 60A, which is particularly thin, and likely to be deformed.

### Terminal Housing Portion

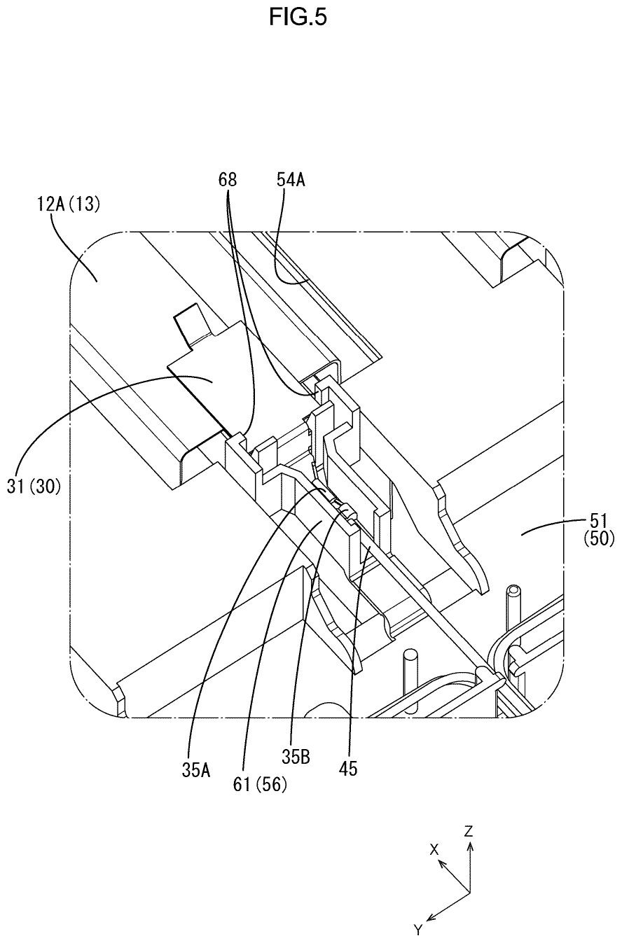

As illustrated in FIG. 6, the terminal housing portion 56 includes a barrel housing recess portion 61 that is connected to the hinge portion 57, a terminal protection portion 62 that is on the back side with respect to the coupling direction, and an intermediate frame portion 63 that is disposed between the barrel housing recess portion 61 and the terminal protection portion 62. The barrel housing recess portion 61 extends in the coupling direction and is recessed rearward and has a gate shape. As illustrated in FIG. 5, a wire barrel portion 35A and an insulation barrel portion 35B of the terminal 30 and a portion of the electric wire 45 are arranged in the barrel housing recess portion 61.

### Terminal Protection Portion

As illustrated in FIG. 11, the terminal protection portion 62 is a plate member and is disposed behind an electrode connection portion 31 of the terminal 30. The terminal protection portion 62 extends downward from a lower end of the intermediate frame portion 63 and is inclined frontward. The terminal protection portion 62 includes a protector side slope surface 62A that is inclined rearward as it extends downward. A portion of the terminal protection portion 62 that is near the upper end portion of the protector side slope surface 62A is defined as a rear stopper portion 62B that can be contacted with the electrode connection portion 31 and suppresses the rearward movement of the terminal 30.

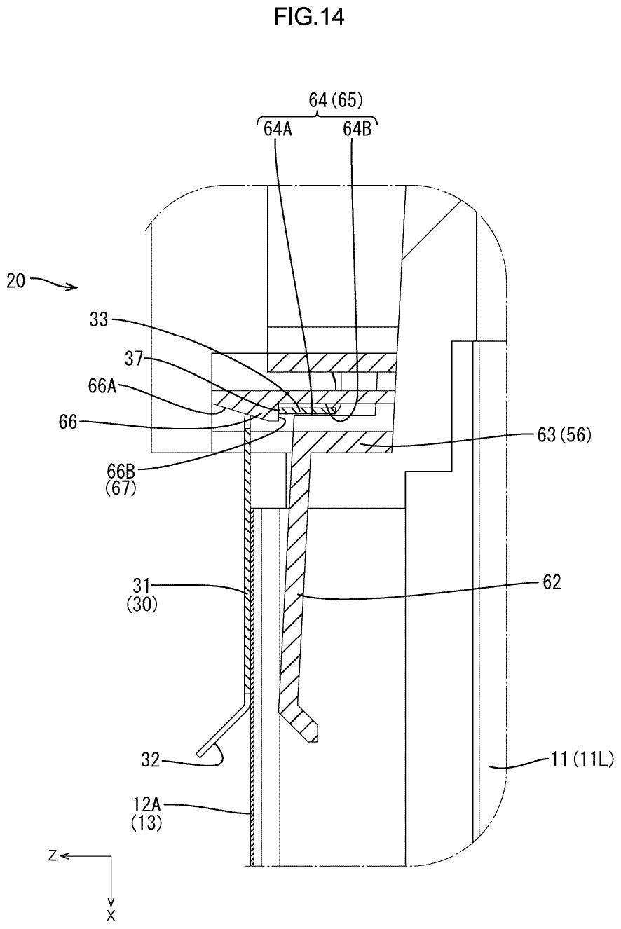

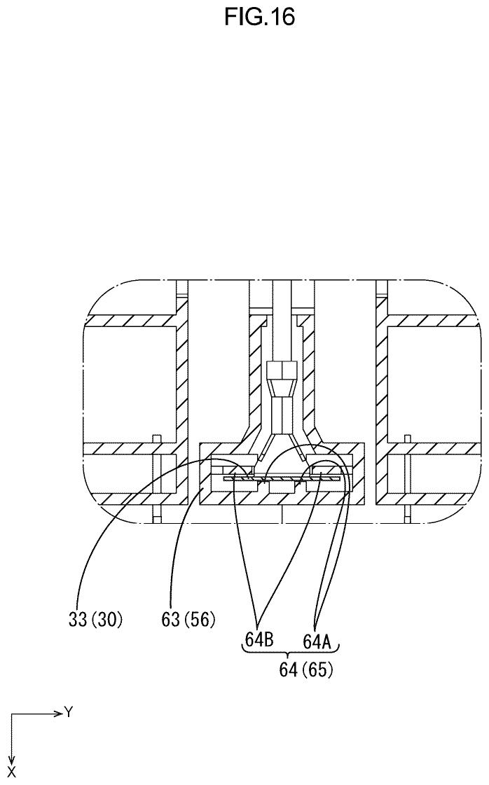

As illustrated in FIGS. 14 and 16, a protector side fitting portion 64 is inside the intermediate frame portion 63. The protector side fitting portion 64 holds the terminal 30 so as to be movable with respect to the terminal housing portion 56 in the front-rear direction. The protector side fitting portion 64 includes lower contact portions 64A and upper contact portions 64B that are spaced from each other in the upper-bottom direction. The lower contact portions 64A are disposed to be contacted with a middle portion of a terminal side fitting portion 33 of the terminal 30 with respect to the right-left direction from a lower side. The upper contact portions 64B are disposed to be contacted with two end portions of the terminal side fitting portion 33 with respect to the right-left direction from an upper side. Thus, the protector side fitting portion 64 is configured as a first movement suppress portion 65 that suppresses moving of the terminal 30 in the upper-bottom direction.

As illustrated in FIG. 14, the upper contact portion 64B includes a stopper protrusion 66, which protrudes downward, on a front section thereof. The stopper protrusion 66 includes a fitting surface 66A and a front stopper portion 66B. The fitting surface 66A is inclined downward as it extends rearward. The front stopper portion 66B extends vertically with respect to the terminal side fitting portion 33 and is configured as a rear edge surface of the stopper protrusion 66. By sliding a rear end portion of the terminal side fitting portion 33 with respect to the fitting surface 66A, the terminal 30 can be arranged in the terminal housing portion 56 easily. With the front stopper portion 66B being contacted with a front end portion of the terminal side fitting portion 33, the terminal 30 is less likely to move frontward.

The front stopper portion 66B (refer to FIG. 14) and the rear stopper portion 62B (refer to FIG. 11) are configured as a stopper 67 that keeps the terminal 30 in the terminal housing portion 56 with respect to the front-rear direction.

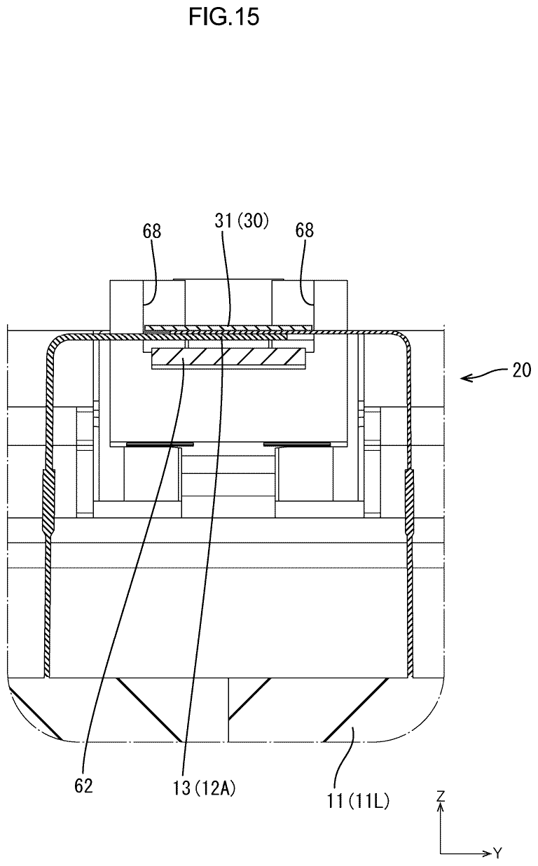

As illustrated in FIG. 6, the intermediate frame portion 63 includes second movement suppress portions 68 having a cutout shape in a lower wall portion thereof. As illustrated in FIGS. 5 and 15, the second movement suppress portions 68 are configured to be contacted with the electrode connection portion 31 of the terminal 30 from the right and left sides to suppress the movement of the terminal 30 in the right-left direction.

### Terminal

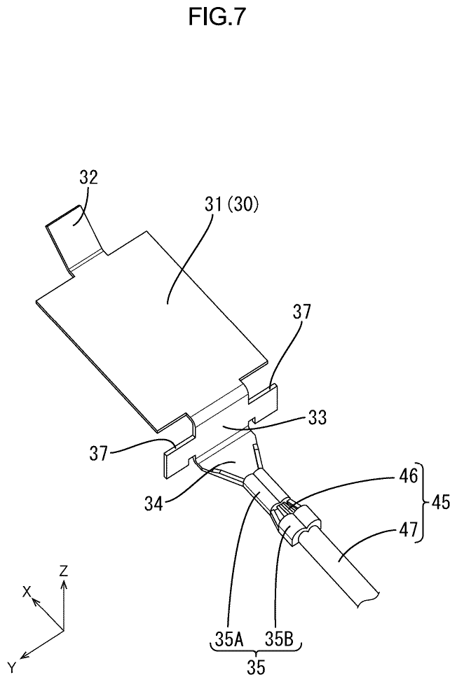

As illustrated in FIG. 7, the terminal 30 is formed by processing an electrically conductive metal plate. The terminal 30 includes the electrode connection portion 31, the slope surface 32 that continuously extends downward from the electrode connection portion 31, and the terminal side fitting portion 33 that extends rearward from the upper end portion of the electrode connection portion 31. A wire connection portion 35 is connected to a rear end portion of the terminal side fitting portion 33 via a joint portion 34. The wire connection portion 35 includes the wire barrel portion 35A that is crimped onto a core wire 46 of the electric wire 45 and the insulation barrel portion 35B that is crimped onto an insulating sheath 47 of the electric wire 45.

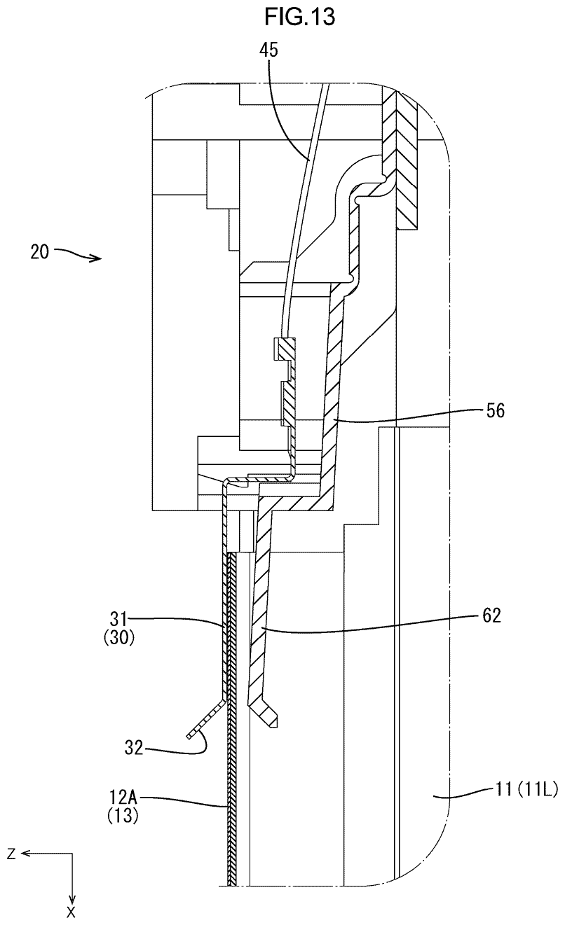

As illustrated in FIG. 13, the terminal 30 is configured to be connected to the connection portion 13 or a portion of the connection electrode lead 12A of the connection portion 13. Namely, the terminal 30 is not for connecting the adjacent connection electrode leads 12A but for connecting the connection electrode leads 12A that are previously connected (the connection portion 13) and the electric wire 45. Therefore, the dimension of the terminals 30 with respect to the upper-bottom direction can be smaller than the dimension of the connection electrode leads 12A with respect to the upper-bottom direction.

### Electrode Connection Portion, First Position

As illustrated in FIG. 11, in the wiring module 20, the electrode connection portion 31 is disposed in front of the terminal protection portion 62. A lower portion of the electrode connection portion 31 is configured as rear stop portion 36 that is contacted with the rear stopper portion 62B. The terminal 30 illustrated in FIG. 11 is in a first position. The first position is a most possible rear position of the terminal 30 in a range that the terminal 30 can move with respect to the terminal housing portion 56 in the front-rear direction. As illustrated in FIG. 13, with the wiring module 20 being coupled to the battery stack member 11L, the connection electrode lead 12A is disposed between the electrode connection portion 31 and the terminal protection portion 62 with respect to the front-rear direction. The electrode connection portion 31 is electrically connected to the connection electrode lead 12A with laser welding.

### Terminal Side Fitting Portion, Second Position

As illustrated in FIG. 14, the terminal side fitting portion 33 has a plate shape and is disposed vertically with respect to the connection portion 13. The thickness direction of the terminal side fitting portion 33 corresponds to the upper-bottom direction. In the wiring module 20, the terminal side fitting portion 33 is arranged between the lower contact portion 64A and the upper contact portion 64B so as to slidably move along the protector side fitting portion 64. With the terminal side fitting portion 33 sliding along the protector side fitting portion 64, the terminal 30 is held in the terminal housing portion 56 so as to be movable in the front-rear direction. As illustrated in FIG. 7, front stop portions 37 having a notch shape are on right and left front edge portions of the terminal side fitting portion 33. As illustrated in FIG. 14, the front stop portions 37 are disposed to be fitted to the front stopper portions 66B. With the front stop portions 37 and the front stopper portions 66B being fitted together, the position of the terminal 30 is in a second position. The second position is a most possible front position of the terminal 30 in a range that the terminal 30 can move with respect to the terminal housing portion 56 in the front-rear direction.

### Slope Surface

As illustrated in FIG. 11, the slope surface 32 is inclined frontward as it extends downward. Namely, the slope surface 32 is farther away from the terminal protection portion 62 with respect to the front-rear direction as it extends downward. With the terminal 30 being in the first position when the wiring module 20 is coupled to the battery stack member 11L, the slope surface 32 is disposed in a range WT where the connection electrode lead 12A is to be disposed with respect to the front-rear direction (hereinafter referred to as a correct position range). The area ranging from the most possible front position of the connection electrode lead 12A to the most possible rear position with considering the tolerance of the connection electrode lead 12A with respect to the front-rear direction is defined as the correct position range WT. In other words, with the connection electrode lead 12A being disposed within the assumed tolerance range in the front-rear direction, the connection electrode lead 12A is supposed to be contacted with the slope surface 32 (details will be described later).

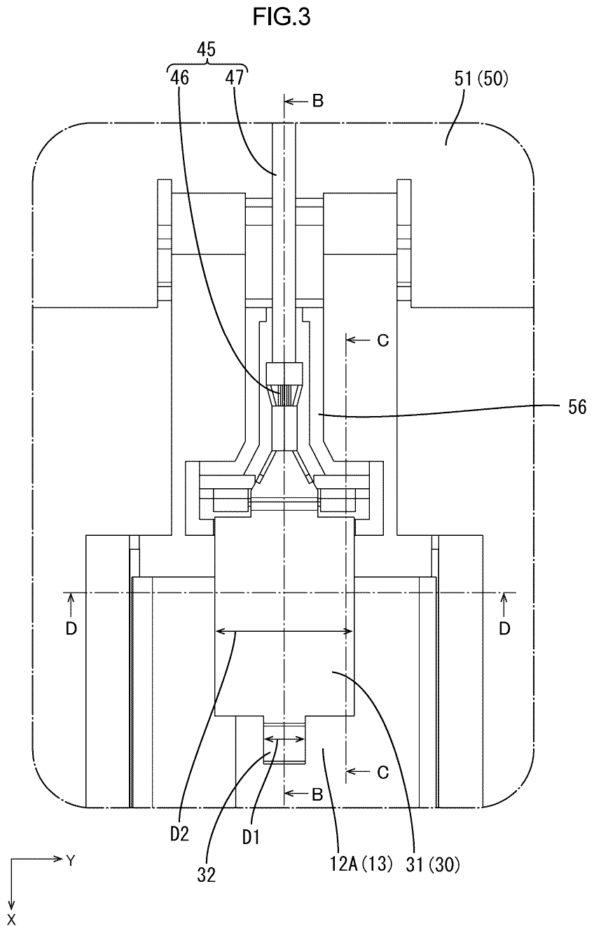

As illustrated in FIG. 3, the slope surface 32 is continuous from a middle of a lower end of the electrode connection portion 31 with respect to the right-left direction. A dimension D1 of the slope surface 32 extending in the right-left direction is smaller than a dimension D2 of the electrode connection portion 31 extending in the right-left direction. Therefore, when the electrode connection portion 31 and the connection electrode lead 12A are closely contacted with each other with a zig, which is not illustrated, and processed with laser welding, the middle section of the electrode connection portion 31 can be welded with the right and left edge portions of the electrode connection portion 31 being pressed with a zig and the slope surface 32 being not pressed.

### Busbar

The busbars 40 have a plate shape and are made by processing a metal plate having electrically conductive properties. As illustrated in FIG. 2, the busbars 40 are held in the busbar holding portions 55 of the protector 50 such that a plate thickness direction of the busbars 40 corresponds to the right-left direction. As illustrated in FIG. 1, a middle section of the busbar 40 is configured as a busbar body portion 41 that is connected to the end portion electrode lead 12B. When the busbar body portion 41 and the end portion electrode lead 12B are connected, the end portion electrode lead 12B may be bent as appropriate so as to be contacted with the busbar body portion 41. The busbar 40 includes an upper portion that is configured as a busbar side connection portion 42 that is bent leftward or rightward with respect to the busbar body portion 41.

As illustrated in FIG. 2, the busbar side connection portion 42 has a through hole (not illustrated) through which a bolt 42A is inserted and thus and the busbar side connection portion 42 is fixed to the bolt fixing portion 55A with the bolt. As illustrated in FIG. 1, an external connection terminal 43 and a relay terminal 44 are disposed on the busbar side connection portion 42 and fixed together with the busbar side connection portion 42 with the bolt. Accordingly, the busbar side connection portion 42 is electrically connected to the external connection terminal 43 and the relay terminal 44. The external connection terminal 43 is an electrically conductive metal plate that is disposed to protrude leftward or rightward with respect to the battery module 10. The external connection terminal 43 is used for connecting the battery module 10 and an external device, which is not illustrated. The relay terminal 44 is an electrically conductive metal plate and for connecting the busbar side connection portion 42 and the electric wire 45. The relay terminal 44 is connected to the electric wire 45 similar to the terminal 30.

### Electric Wire

As illustrated in FIG. 3, the electric wire 45 includes the core wire 46 (not illustrated in the drawings other than FIGS. 3 and 7) and the insulating sheath 47 that covers the core wire 46. As illustrated in FIG. 2, one end of each electric wire 45 is connected to the terminal 30 or the relay terminal 44 and other ends of the electric wires 45 are collectively connected to the connector 48. The electric wires 45 are routed in predefined sections of the protector 50 with routing protrusions 69, electric wire holders 70, and a routing groove 71 that are on the protector 50.

The connector 48 is made of synthetic resin having insulating properties and has a block shape as illustrated in FIG. 1. The connector 48 includes a female terminal, which is not illustrated, therein. The connector 48 is to be fitted to a target connector including a male terminal. The target connector is connected to an external ECU (electronic control unit) via an electric wire, which is not illustrated. The ECU has a known configuration including a microcomputer and components and has a function of detecting a voltage, a current, and a temperature of each laminated type battery 11 and has a function of controlling charging and discharging of each laminated type battery 11.

The present embodiment has the above-described configuration and operations of the terminal 30 at the time of coupling of the wiring module 20 and the battery stack member 11L will be described.

First, the operations with the connection electrode lead 12A being disposed in the correct position range WT will be described with reference to FIGS. 11 to 14. In FIGS. 11 to 14, the connection electrode lead 12A is in a very front section of the correct position range WT. As illustrated in FIG. 11, with the terminal 30 being in the first position before the connection electrode lead 12A is coupled to the battery stack member 11L (hereinafter, referred to as a pre-coupling state), the upper end portion of the connection electrode lead 12A is to come in contact with the slope surface 32. When the connection electrode lead 12A comes in contact with the slope surface 32, the terminal 30 receives a force toward the front side (upward) in the coupling direction. As illustrated in FIGS. 14 and 16, since the terminal side fitting portion 33 is surface-contacted with the protector side fitting portion 64 in the upper-bottom direction, the terminal side fitting portion 33 receives the upward force with being spread in the terminal housing portion 56. Since the terminal housing portion 56 is movable with respect to the protector body 51 with the hinge portion 57, the hinge portion 57 is bent mainly at the second reduced thickness portion 60B to absorb the upward force applied to the terminal housing portion 56 (refer to FIG. 6).

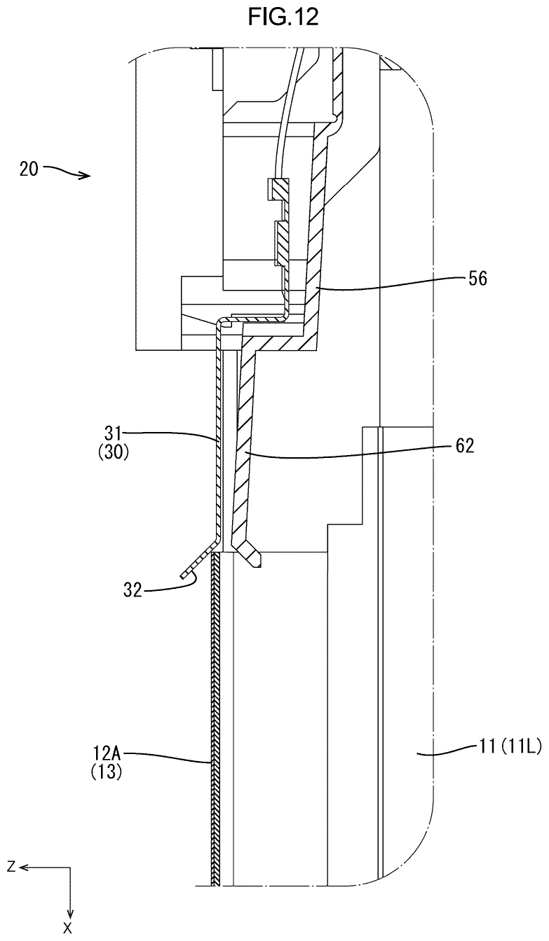

As illustrated in FIG. 12, as the wiring module 20 moves downward, the upper end portion of the connection electrode lead 12A slides along the slope surface 32 and this moves the terminal 30 frontward. As illustrated in FIG. 13, as the wiring module 20 moves further downward, the electrode connection portion 31 is arranged in front of the connection electrode lead 12A. With the connection electrode lead 12A being in the very front section of the correct position range WT as illustrated in FIG. 14, the front stop portions 37 of the terminal 30 and the front stopper portions 66B of the terminal housing portion 56 are fitted together (in the second position). Namely, as long as the connection electrode lead 12A is in the correct position range WT, the frontward movement of the terminal 30 may not be prohibited.

In the pre-coupling state, with the terminal 30 being on the front side of the first position, the upper end portion of the connection electrode lead 12A comes in contact with the slope surface 32 as previously described or does not come in contact with the slope surface 32 and directly enter a space between the electrode connection portion 31 and the terminal protection portion 62. Therefore, when the wiring module 20 is coupled to the battery stack member 11L, the terminal 30 is less likely to hit the connection electrode lead 12A.

Furthermore, in this embodiment, even with the connection electrode lead 12A being not disposed in the correct position range WT, the terminal housing portion 56 moves with respect to the protector body 51 when the wiring module 20 is coupled to the battery stack member 11L, and therefore, the connection electrode lead 12A is likely to be disposed between the electrode connection portion 31 and the terminal protection portion 62.

With the connection electrode lead 12A being disposed outside (behind) the correct position range WT and close to the terminal protection potion 62 as illustrated in FIGS. 17 and 18, the operations are as follows. With the upper end portion of the connection electrode lead 12A being in contact with the protector side slope surface 62A of the terminal protection portion 62, as the wiring module 20 moves downward, the upper end portion of the connection electrode lead 12A slides along the protector side slope surface 62A and this applies a rearward force to the terminal housing portion 56. As illustrated in FIG. 18, with the hinge portion 57 being bent mainly at the first reduced thickness portions 60A, the terminal housing portion 56 moves rearward corresponding to the position of the connection electrode lead 12A in the front-rear direction. Thus, the connection electrode lead 12A can be arranged between the electrode connection portion 31 and the terminal protection portion 62 without hitting the terminal protection portion 62.

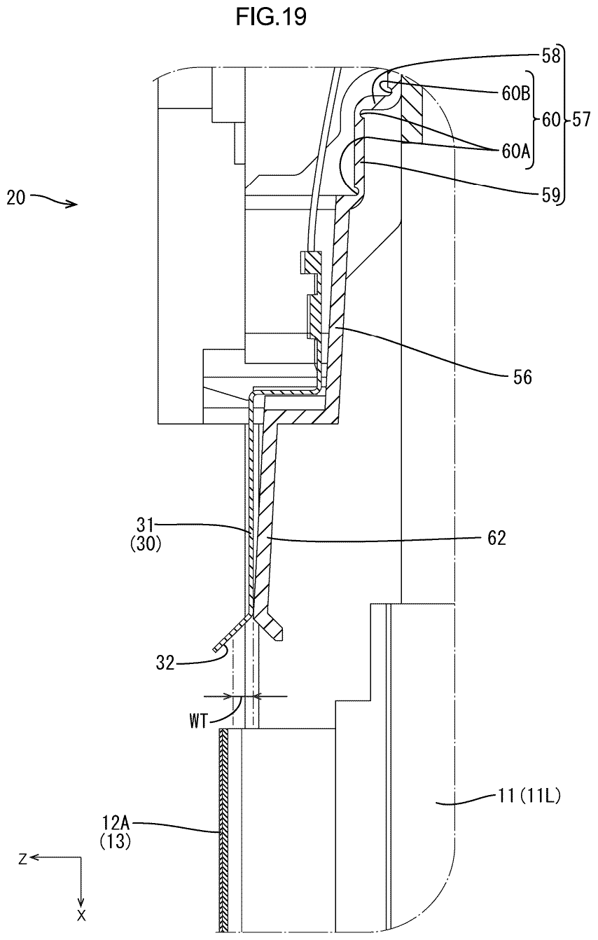

With the connection electrode lead 12A being disposed outside (in front of) the correct position range WT and close to the slope surface 32 as illustrated in FIGS. 19 and 20, the operations are as follows. With the upper end portion of the connection electrode lead 12A being in contact with the slope surface 32, as the wiring module 20 moves downward, the upper end portion of the connection electrode lead 12A slides along the slope surface 32 and the terminal 30 is to be moved frontward. Since the connection electrode lead 12A is in front of the correct position range WT, the front stop portions 37 and the front stopper portions 66B are fitted together while the connection electrode lead 12A sliding along the slope surface 32 and the terminal 30 cannot move frontward with respect to the terminal housing portion 56 (refer to FIG. 14). This applies a frontward force to the terminal housing portion 56. As illustrated in FIG. 20, with the hinge portion 57 being bent at the first reduced thickness portions 60A, the terminal housing portion 56 moves frontward corresponding to the position of the connection electrode lead 12A in the front-rear direction. Thus, the connection electrode lead 12A can be arranged between the electrode connection portion 31 and the terminal protection portion 62 without hitting the slope surface 32.

### Operations and Effects of First Embodiment

According to the first embodiment, operations and effects described below are obtained.

The wiring module 20 according to the first embodiment is to be coupled to the battery stack member 11L including the laminated type batteries 11 that are stacked. The laminated type batteries 11 include the electrode leads 12. The electrode leads 12 are overlapped and connected to be configured as the connection portion 13. The wiring module 20 is to be coupled to the battery stack member 11L including the connection portions 13 in the coupling direction that is perpendicular to the plate thickness direction of the connection portion 13. The wiring module 20 includes the terminals 30, the electric wires 45 connected to the terminals 30, and the protector 50 that holds the terminals 30 and the electric wires 45. The protector 50 includes the terminal housing portions 56 in which the terminals 30 are arranged and the protector side fitting portion 64 that holds the terminal 30 so as to be movable in the plate thickness direction between the first position and the second position with respect to the terminal housing portion 56. The second position is on one side with respect to the first position in the plate thickness direction. Some of the electrode leads 12 that are configured as the connection portions 13 are defined as the connection electrode leads 12A. The terminal 30 includes the electrode connection portion 31, the slope surface 32, and the terminal side fitting portion 33. The electrode connection portion 31 is electrically connected to the connection portion 13. The slope surface 32 is continuous to the electrode connection portion 31 and is inclined toward the one side with respect to the plate thickness direction as it extends toward the back side with respect to the coupling direction. The terminal side fitting portion 33 is to be fitted to the protector side fitting portion 64. With the terminal 30 being in the first position, the slope surface 32 is disposed in the range WT in which the connection electrode lead 12A is to be disposed with respect to the plate thickness direction.

With the configuration described above, when the wiring module 20 is coupled to the battery stack member 11L, with the slope surface 32 being fitted to the end portion of the connection electrode lead 12A on the front side with respect to the coupling direction, the terminal 30 moves in the plate thickness direction with respect to the connection electrode lead 12A. Therefore, the terminal 30 is less likely to hit the connection electrode lead 12A.

In the first embodiment, the terminal housing portion 56 includes the terminal protection portion 62 that is disposed opposite the electrode connection portion 31 with respect to the plate thickness direction. The slope surface 32 is inclined so as to be away from the terminal protection portion 62 as it extends toward the back side in the coupling direction. The connection electrode lead 12A is disposed between the electrode connection portion 31 and the terminal protection portion 62 with respect to the plate thickness direction.

With the configuration described above, the terminal 30 can be protected by the terminal protection portion 62. Furthermore, the connection electrode lead 12A that is disposed between the electrode connection portion 31 and the terminal protection portion 62 can be protected.

In the first embodiment, the terminal protection portion 62 includes the protector side slope surface 62A at the end portion on the back side with respect to the coupling direction. The protector side slope surface 62A is inclined toward other side with respect to the plate thickness direction as it extends toward the back side with respect to the coupling direction.

With the configuration described above, even if the connection electrode lead 12A is disposed outside the range WT where the connection electrode lead 12A is to be disposed with respect to the plate thickness direction and closer to the terminal protection portion 62, the connection electrode lead 12A is likely to be arranged between the electrode connection portion 31 and the terminal protection portion 62.

In the first embodiment, the direction perpendicular to the plate thickness direction and the coupling direction is defined as the terminal width direction. The dimension D1 of the slope surface 32 extending in the terminal width direction is smaller than the dimension D2 of the electrode connection portion 31 extending in the terminal width direction.

With the configuration described above, the electrode connection portion 31 and the connection electrode lead 12A are electrically connected easily.

In the first embodiment, the terminal housing portion 56 includes the stopper 67 that keeps the terminal 30 in the terminal housing portion 56 with respect to the plate thickness direction.

With the above configuration, the terminal 30 is less likely to be away from the terminal housing portion 56.

In the first embodiment, the terminal housing portion 56 includes the first movement suppress portion 65 that suppresses the movement of the terminal 30 in the coupling direction and the second movement suppress portions 68 that suppress the movement of the terminal 30 in the terminal width direction.

With the above configuration, the terminal 30 can be positioned with respect to the terminal housing portion 56 in the coupling direction and the terminal width direction.

In the first embodiment, the terminal side fitting portion 33 has a plate shape and is disposed vertically with respect to the connection portion 13. The protector side fitting portion 64 that is to be contacted with the terminal side fitting portion 33 on the back side and the front side with respect to the coupling direction is configured as the first movement suppress portion 65.

With the above configuration, since the terminal side fitting portion 33 has a plate shape that is vertical to the connection portion 13, when the wiring module 20 is coupled to the battery stack member 11L, the force that is applied to the terminal 30 in the coupling direction is likely to be spread. With the protector side fitting portion 64 being configured as the first movement suppress portion 65, the configuration of the terminal housing portion 56 can be simplified.

In the first embodiment, the protector 50 includes the protector body 51 and the terminal housing portion 56 is movably connected to the protector body 51 via the hinge portion 57.

With the above configuration, even if the connection electrode lead 12A is disposed outside the range WT where the connection electrode lead 12A is to be disposed with respect to the plate thickness direction, the connection electrode lead 12A is likely to be arranged between the electrode connection portion 31 and the terminal protection portion 62.

### Second Embodiment

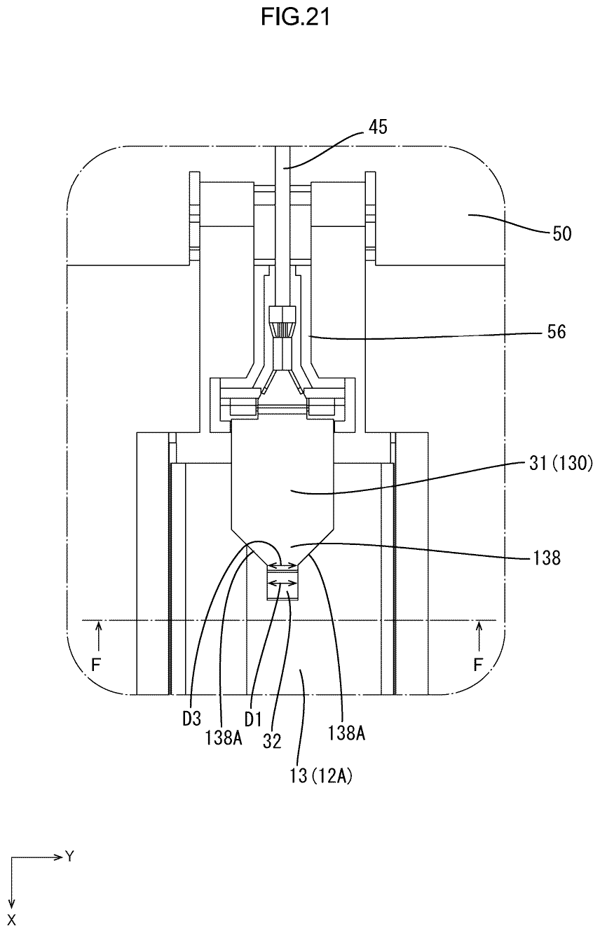

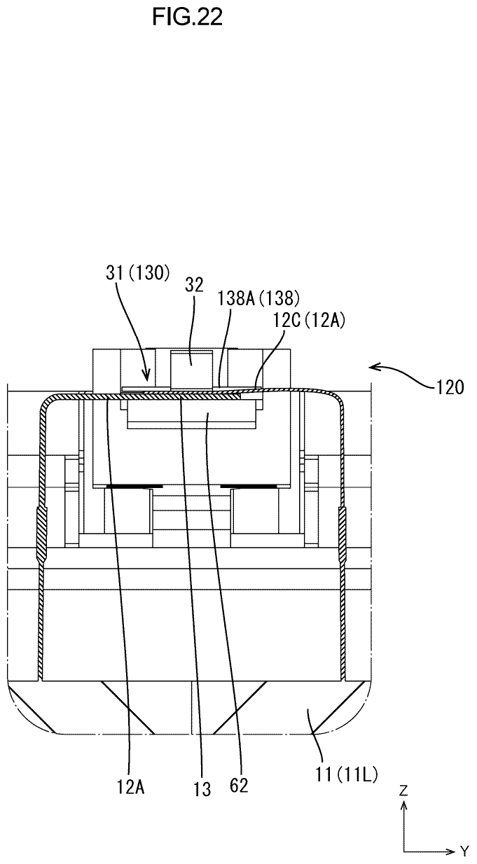

A second embodiment of the present disclosure will be described with reference to FIGS. 21 and 22. A wiring module 120 according to the second embodiment has a configuration same as that of the wiring module 20 of the first embodiment except for a terminal 130 including a trapezoid portion 138. In the following description, the components having the same configuration as those of the first embodiment are indicated by the reference signs of the first embodiment and the components having the same configurations as those of the first embodiment and operations and effects same as those of the first embodiment will not be described.

### Trapezoid Portion

As illustrated in FIG. 21, the terminal 130 includes the trapezoid portion 138 that is between the slope surface 32 and the electrode connection portion 31. The trapezoid portion 138 is on the same plane as the electrode connection portion 31. The trapezoid portion 138 has a dimension extending in the terminal width direction (the right-left direction) that decreases as it extends toward the back side in the coupling direction (downward). The trapezoid portion 138 has a symmetrical shape with respect to the right-left direction. A lower end portion of the trapezoid portion 138 is in a position corresponding to a middle of the electrode connection portion 31 with respect to the right-left direction and continuous to the slope surface 32. The lower end portion of the trapezoid portion 138 has a dimension D3 extending in the right-left direction and the dimension D3 is same as the dimension D1 of the slope surface 32 extending in the right-left direction. The trapezoid portion 138 has edge portions 138A that continuously connect the right and left edge portions of the slope surface 32 and the right and left edge portions of the electrode connection portion 31, respectively.

As illustrated in FIG. 22, with the connection electrode lead 12A disposed in the position so as not to be contacted with the slope surface 32 having an outer portion 12C warped toward the terminal 130 (frontward), the operations as follows. FIG. 22 illustrates the wiring module 120 that is being coupled to the battery stack member 11L and before the upper end portion of the connection electrode lead 12A being contacted with the terminal 130. With the terminal 30 of the first embodiment being used, the slope surface 32 and the electrode connection portion 31 that have different dimensions in the right-left direction are connected without having a trapezoid portion therebetween (refer to FIG. 3). With such a configuration, when the wiring module 20 is coupled to the battery stack member 11L, the outer portion 12C of the connection electrode lead 12A may hit the lower end portion of the electrode connection portion 31.

However, in this embodiment, as illustrated in FIG. 21, the trapezoid portion 138 (the electrode connection portion 31) is between the slope surface 32 and the electrode connection portion 31 so as to continuously extend in the right-left direction. Therefore, when the wiring module 120 is coupled to the battery stack member 11L, the outer portion 12C of the connection electrode lead 12A slides along the edge portion 138A of the trapezoid portion 138 in FIG. 22. Thus, the connection electrode lead 12A is less likely to hit the electrode connection portion 31.

### Operations and Effects of Second Embodiment

According to the second embodiment, operations and effects described below are obtained.

In the second embodiment, the slope surface 32 is disposed corresponding to a middle of the electrode connection portion 31 with respect to the terminal width direction. The electrode connection portion 31 is connected to the slope surface 32 via the trapezoid portion 138 whose dimension extending in the terminal width direction decreases as it extends toward the back side in the coupling direction. The trapezoid portion 138 has a symmetrical shape with respect to the terminal width direction. The end portion of the trapezoid portion 138 on the back side in the coupling direction has the dimension D3 extending in the terminal width direction and the dimension D3 is preferably same as the dimension D1 of the slope surface 32 extending in the terminal width direction.

With the above configuration, the electrode connection portion 31 is less likely to hit a portion of the connection electrode lead 12A that is disposed outside the slope surface 32 in the terminal width direction.

### Other Embodiments

(1) In the above embodiments, the two electrode leads 12 are connected and configured as the connection portion 13 and the laminated type batteries 11 are connected in series; however, the configuration is not limited to the above one. Three or more electrode leads may be connected and configured as a connection portion and the laminated type batteries may be connected in parallel.
(2) In the above embodiments, the terminal housing portion 56 includes the terminal protection portion 62; however, the terminal housing portion 56 does not necessarily have such a configuration and the terminal protection portion may not be included.
(3) In the above embodiments, the terminal housing portion 56 is movably connected to the protector body 51 via the hinge portion 57; however, the terminal housing portion may not have the above configuration and may be configured not to be movable with respect to the protector body.
(4) In the above embodiments, the battery module 10 includes the casing 14; however, the configuration may not be limited thereto and the battery module may not include a casing.

### EXPLANATION OF SYMBOLS

10: Battery module
11: Laminated type battery
11L: Battery stuck member
12: Electrode lead
12A: Connection electrode lead
12B: End portion electrode lead
12C: Outer portion of the connection electrode lead
13: Connection portion
14: Casing
15: Bottom portion
16: Ceiling portion
17: Side portion
20, 120: Wiring module
30, 130: Terminal
31: Electrode connection portion
32: Slope surface
33: Terminal side fitting portion
34: Joint portion
35: Wire connection portion
35A: Wire barrel portion
35B: Insulation barrel portion
36: Rear stop portion
37: Front stop portion
40: Busbar
41: Busbar body portion
42: Busbar side connection portion
42A: Bolt
43: External connection terminal
44: Relay terminal
45: Electric wire
46: Core wire
47: Insulating sheath
48: Connector
50: Protector
51: Protector body
54: Electrode receiving portion
54A: Connection electrode receiving portion
54B: End portion electrode receiving portion
55: Busbar holding portion
55A: Bolt fixing portion
56: Terminal housing portion
57: Hinge portion
58: Protrusion section
59: Extending section
60: Reduced thickness portion
60A: First reduced thickness portion
60B: Second reduced thickness portion
61: Barrel housing recess portion
62: Terminal protection portion
62A: Protector side slope surface
62B: Rear stopper portion
63: Intermediate frame portion
64: Protector side fitting portion
64A: Lower contact portion
64B: Upper contact portion
65: First movement suppress portion
66: Stopper protrusion
66A: Fitting surface
66B: Front stopper portion
67: Stopper
68: Second movement suppress portion
69: Routing protrusions
70: Electric wire holder
71: Routing groove
138: Trapezoid portion
138A: Edge portion of the trapezoid portion
D1: Dimension of the slope surface extending in the terminal width direction
D2: Dimension of the electrode connection portion extending in the terminal width direction
D3: Dimension of an end portion of the trapezoid portion on the back side with respect to the coupling direction extending in the terminal width direction
WT: Range where the connection electrode lead is to be disposed with respect to the plate thickness direction (correct position range)

1. A wiring module to be coupled to a battery stack member that includes laminated type batteries having electrode leads being stacked, the electrode leads of the laminated type batteries being overlapped and connected and configured as connection portions, the wiring module being to be coupled to the battery stack member including the connection portions in a coupling direction that is perpendicular to a plate thickness direction of the connection portions, the wiring module comprising:
terminals;
electric wires connected to the terminals; and
a protector holding the terminals and the electric wires, wherein
the protector includes terminal housing portions in which the terminals are disposed, and protector side fitting portions that hold the terminals so as to be movable in the plate thickness direction with respect to the terminal housing portions between a first position and a second position,
the second position is on one side with respect to the first position in the plate thickness direction,
the electrode leads include connection electrode leads that are configured as the connection portions,
the terminals include electrode connection portions that are electrically connected to the connection electrode leads, slope surfaces that are continuous to the electrode connection portions and are inclined toward the one side with respect to the plate thickness direction as the slope surfaces extend toward a back side in the coupling direction, and terminal side fitting portions that are fitted to the protector side fitting portions, and
with one of the terminals being disposed in the first position, corresponding one of the slope surfaces is disposed in a range in which corresponding one of the connection electrode leads is to be disposed with respect to the plate thickness direction.

2. The wiring module according to claim 1, wherein
the terminal housing portions include terminal protection portions that are disposed opposite the electrode connection portions with respect to the plate thickness direction,
the slope surfaces are inclined so as to be away from the terminal protection portions as the slope surfaces extend toward the back side with respect to the coupling direction, and
the connection electrode leads are disposed between the electrode connection portions and the terminal protection portions, respectively, with respect to the plate thickness direction.

3. The wiring module according to claim 2, wherein the terminal protection portions include protector side slope surfaces at end portions on the back side with respect to the coupling direction and the protector side slope surfaces are inclined toward another side with respect to the plate thickness direction as the protector side slope surfaces extend toward the back side with respect to the coupling direction.

4. The wiring module according to claim 1, wherein
a direction perpendicular to the plate thickness direction and the coupling direction is defined as a terminal width direction, and
a dimension of the slope surfaces extending in the terminal width direction is smaller than a dimension of the electrode connection portions extending in the terminal width direction.

5. The wiring module according to claim 4, wherein
the slope surfaces are in middle sections of the electrode connection portions with respect to the terminal width direction,
the electrode connection portions are continuous to the slope surfaces via trapezoid portions whose dimension extending in the terminal width direction decreases as the trapezoid portions extend toward the back side in the coupling direction,
the trapezoid portions have a symmetrical shape with respect to the terminal width direction, and
end portions of the trapezoid portions on the back side with respect to the coupling direction have a dimension extending in the terminal width direction and the dimension of the end portions of the trapezoid portions is same as a dimension of the slope surfaces extending in the terminal width direction.

6. The wiring module according to claim 1, wherein the terminal housing portions include stoppers that keep the terminals in the terminal housing portions with respect to the plate thickness direction.

7. The wiring module according to claim 1, wherein the terminal housing portions include first movement suppress portions that suppress movement of the terminals in the coupling direction and second movement suppress portions that suppress movement of the terminals in the terminal width direction that is perpendicular to the plate thickness direction and the coupling direction.

8. The wiring module according to claim 7, wherein
the terminal side fitting portions have a plate shape and are disposed vertically with respect to the connection portions, and
the protector side fitting portions are contacted with the terminal side fitting portions on the back side and a front side with respect to the coupling direction and are configured as the first movement suppress portions.

9. The wiring module according to claim 1, wherein
the protector includes a protector body, and
the terminal housing portions are connected movably to the protector body via a hinge portion.
